(19) United States
(12) Patent Application Publication
(10) Pub. No.: US 2016/0019754 A1
(43) Pub. Date: Jan. 21, 2016

(54) Method to increase participation in an undersold side of a bet without adjusting odds or spread

(71) Applicants: George Skaff Elias, Redmond, WA (US); Richard Channing Garfield, Bellevue, WA (US)

(72) Inventors: George Skaff Elias, Redmond, WA (US); Richard Channing Garfield, Bellevue, WA (US)

(21) Appl. No.: 14/545,960

(22) Filed: Jul. 13, 2015

Related U.S. Application Data
(60) Provisional application No. 61/999,064, filed on Jul. 15, 2014.

(51) Int. Cl. G07F 17/32

(52) U.S. Cl. CPC G07F 17/3255

(57) ABSTRACT

The invention is a new method of increasing participation in an undersold side of a bet by means of virtual goods or merchandise.

### CROSS-REFERENCE TO RELATED APPLICATIONS

Applicants are claiming the benefit of a provisional patent application with the same title, No. 61/999,064, filed on Jul. 15, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the field of games. More particularly, the present invention is in the field of betting or wagering games.

### SUMMARY OF THE INVENTION

The present invention is a method to help achieve parity on two sides of a bet without adjusting the odds or any applicable spread.

### BRIEF DESCRIPTION OF THE DRAWINGS

No drawing is necessary to understand or implement the invention.

### DETAILED DESCRIPTION OF THE INVENTION

In a wagering or betting game, the game operator could balance the amounts of bets and expected payout by setting and adjusting the odds that determine the payout of a bet or wager on a particular event or by adjusting the spread between the two sides of a comparative bet. Such adjustments can greatly complicate the user interface of the game.

The present invention is a new method for balancing the expected value of a bet or wager in such a game without adjusting the odds or any applicable spread. Specifically, a game operator can use virtual goods or merchandise as additional incentive for players or participants to take a particular undersold side of a bet. The incentive can either be in the form of rewards for simply taking a particular side of a bet regardless of outcome, or as additional bonus if a particular side of the bet wins.

Examples of these virtual goods and merchandise can include but are not limited to: titles, chat priority, avatars, bonus points that can be used to buy real or virtual goods at a later time, etc.

The new method allows a game operator to achieve parity on two sides of a bet without adjusting the odds or any applicable spread. Such a method is especially well-suited for a community gaming system involving fantasy sports or other fantasy games.

A game operator can determine or estimate the relative value of the relevant virtual goods by tracking any market for the sale or exchange of those goods in the gaming community, or by compiling statistics on the perceived value of those goods when used as incentives. Such knowledge can help a game operator determine the appropriate amounts and types of virtual goods that could be used to increase participation on an undersold side of a bet and thereby help the game operator achieve the required or desired parity.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A new method to achieve parity on two sides of a bet without adjusting the odds or any applicable spread, wherein a game operator can use virtual goods and merchandises as additional incentive for players or participants to take a particular undersold side of a bet. The incentive can either be in the form of rewards for simply taking a particular side of a bet regardless of outcome, or as additional bonus if a particular side of the bet wins.
